(19) United States
(12) Patent Application Publication
(10) Pub. No.: US 2003/0147646 A1
(43) Pub. Date: Aug. 7, 2003

(54) Combined phase and intensity modulation in optical communication systems

(76) Inventor: Mario Zitelli, Rome (IT)

Correspondence Address: Mario Zitelli, Via Enrico Fermi, 130, Rome, 00146, IT

(21) Appl. No.: 10/345,244

(22) Filed: Jan. 16, 2003

(30) Foreign Application Priority Data
Feb. 4, 2002 (IT) RM2002A000056

(51) Int. Cl. H04B 10/04; H04B 14/06

(52) U.S. Cl. 398/65; 398/185; 398/154; 398/161

(57) ABSTRACT

An optical communication system comprising an apparatus to transmit at least a digital optical signal modulated with a first encoded sequence of optical dark pulses and with a second encoded sequence of optical phase, an optical transmission line and an apparatus to receive, the said optical signal having high spectral efficiency.

### FIELD OF THE INVENTION

The invention relates to the transmission of optical signals in optical fiber communication systems, with improved capacity [bit/s] and spectral efficiency [bit/s/Hz], and with reduced bandwidth for the used electronic and opto-electronic devices.

### BACKGROUND OF THE INVENTION

In digital optical communication systems of the last generation, the wavelength division multiplexing (WDM) technique is commonly used to increase the overall transport capacity [bit/s]; in this technique, several digital optical signals at different wavelengths are transmitted together in the same optical fiber, notably increasing the system capacity. Systems have however a limited optical bandwidth, mainly by the optical amplifiers, and this makes necessary to transmit the WDM channels with reduced optical frequency spacing. The spectral efficiency [bit/s/Hz], defined as the ratio between the bit rate R [bit/s] for each WDM channel and the frequency spacing among these, is therefore a parameter of fundamental importance in the design of an optical transport network.

Recently, WDM systems have been proposed using the common Intensity Modulated Direct Detection (IM-DD) modulation format, with spectral efficiencies up to 0.8 bit/s/Hz. In a job [T. Ito et al., “6.4 Tb/s WDM transmission experiment with 0.8 bit/s/Hz spectral efficiency”, proc. of ECOC 2000, PD1.1 (2000)], the transmission of 160 IM-DD channels at 40 Gb/s each and with 50 GHz spacing has been shown on a 200 km system; an efficiency of 0.8 bit/s/Hz has been reached thanks to the Polarization Interleaving (PI) technique, that will be taken back in the following. In another job [W. Idler et al., “Vestigial Side Band demultiplexing for ultra high capacity (0.64 bit/s/Hz) transmission of 128×40 Gbit/s channels”, proc. of OFC 2001, MM3-2 (2001)], the transmission of 128 IM-DD channels has been shown at 40 Gbit/s per channel, with a varying spacing between 50 and 75 GHz; the efficiency was here 0.64 bit/s/Hz, thanks to the technique of the Vestigial Side-Band (VSB).

The IM-DD modulation introduces substantially two disadvantages:

the value of 0.8 bit/s/Hz seems to be an intrinsic limit for optical systems based on this modulation format;

WDM channels, for instance at 40 Gbit/s, require transmitters and receivers with electrical bandwidths comparable with the channel bit rate, for instance 40 GHz; this may involve prohibitive costs of realization.

### BRIEF SUMMARY OF THE INVENTION

The invention relates to an optical communication system in which at least one digital optical signal is transmitted with a new type of optical modulation format, having spectral efficiency that can overcome the value of 1.6 bit/s/Hz, a method to get such efficiency and a modulation device usable in this system and for this method.

The purpose of the invention is the increase of the transmission capacity [bit/s] and of the spectral efficiency [bit/s/Hz] in optical transmission systems, up to values of the order of 1.6 bit/s/Hz. Besides this, the present invention allows to optically multiplex and de-multiplex from two to four electrical tributaries with bit rate R [bit/s] each, in an single optical WDM channel; it is possible to transmit an optical channel with bit rate up to four times R using, in transmitters and receivers according to the present invention, electronic and opto-electronic devices with electrical bandwidth comparable with R. For instance, it is possible to obtain channels at 40 Gbit/s by the optical multiplexing of four tributaries at 10 Gbit/s, exclusively using standard 10 GHz electronics, or to obtain channels at 160 Gbit/s with spacing up to 100 GHz, using 40 GHz electronics.

### BRIEF DESCRIPTION OF THE SEVERAL VIEWS OF THE DRAWING

The following figures illustrate better the present invention by way of example and without restrictions, detailed descriptions will be given in the following section:

FIG. 1a illustrates a transmission system and modulation scheme according to a first and a second aspect of the present invention;

FIG. 2 illustrates a scheme of transmission system according to a third aspect of the present invention;

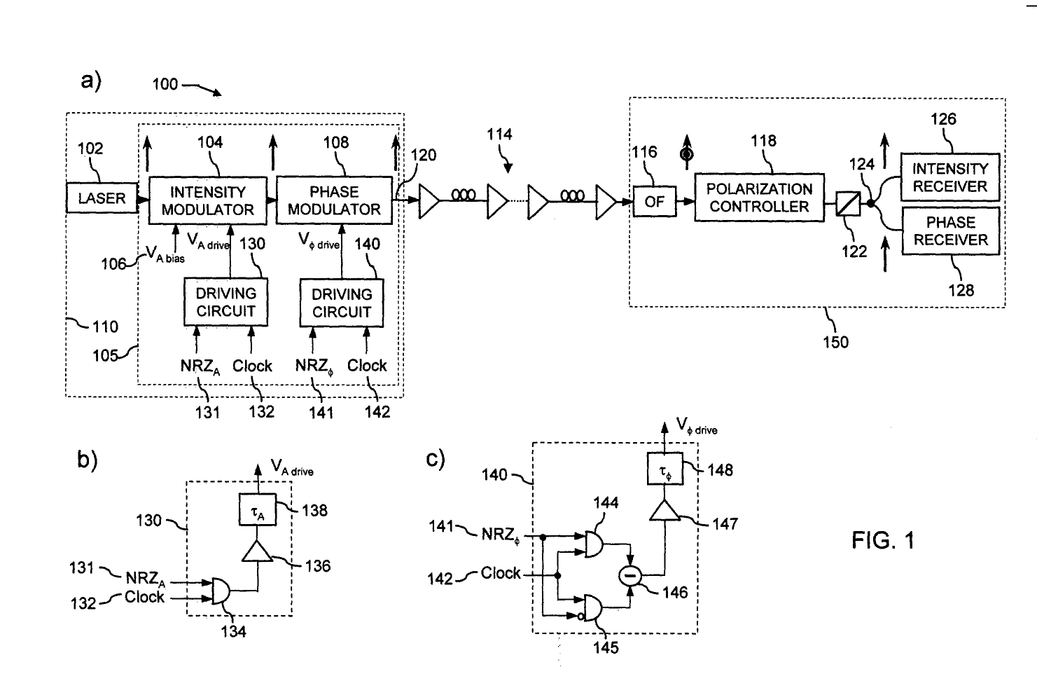

FIGS. 1b, 1c, 3a, 3b and 3c illustrate some schemes of possible driving circuits to be used in the systems and modulators according to the first, second and third aspect of the present invention;

FIGS. 3d and 3e illustrate some schemes of possible receivers of optical intensity and phase to be used in the systems according to the first and third aspect of the present invention;

FIG. 4 illustrates some temporal diagrams of the optical and electrical signals used in the systems and modulators according to the first, second and third aspect of the present invention;

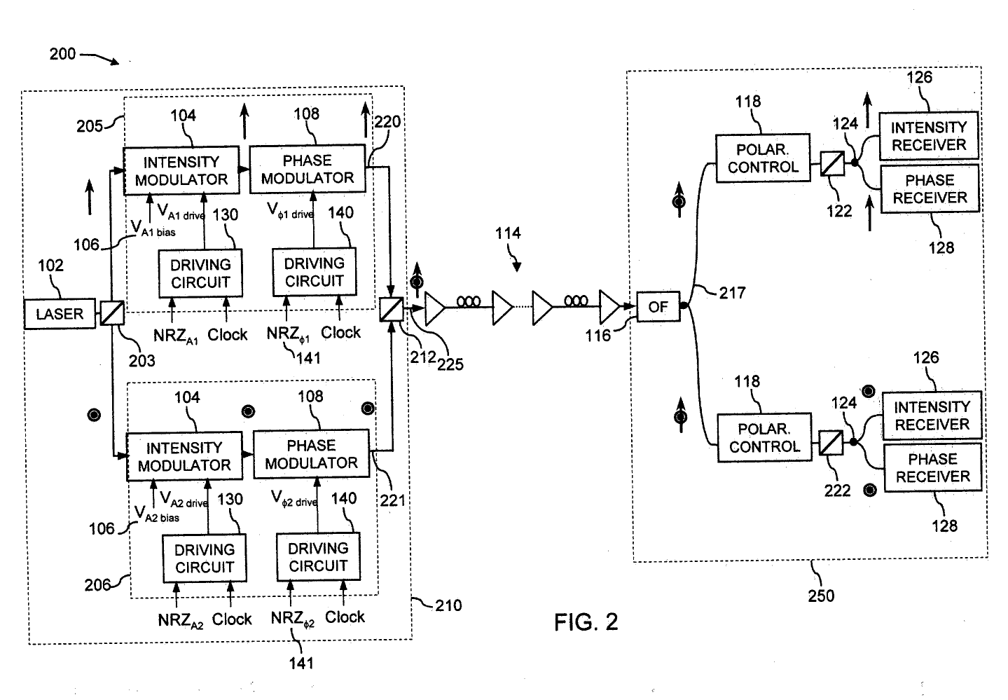

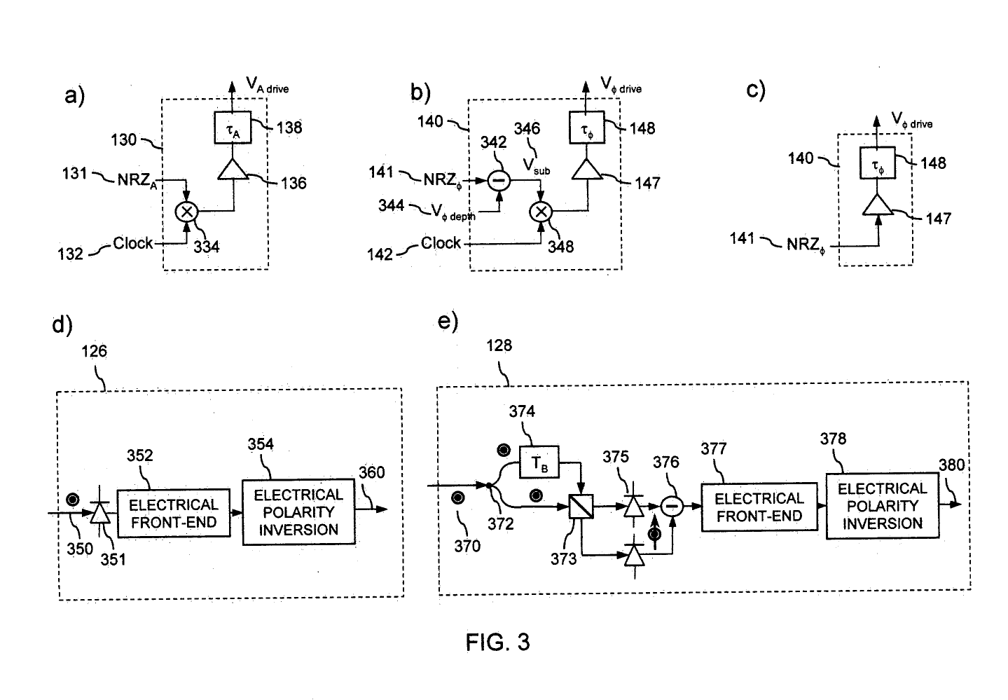

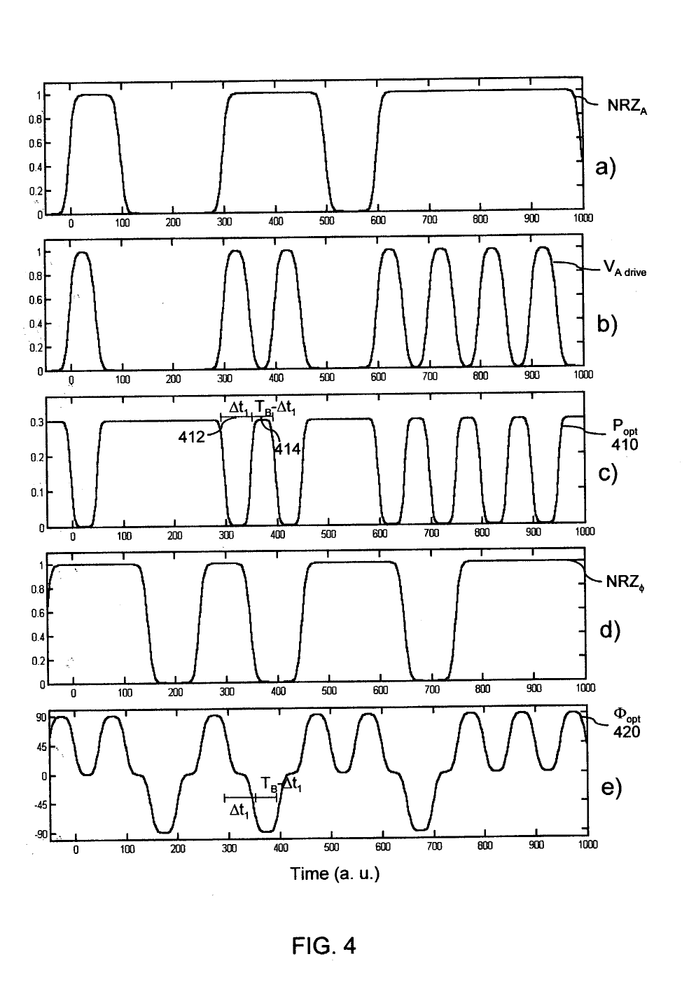

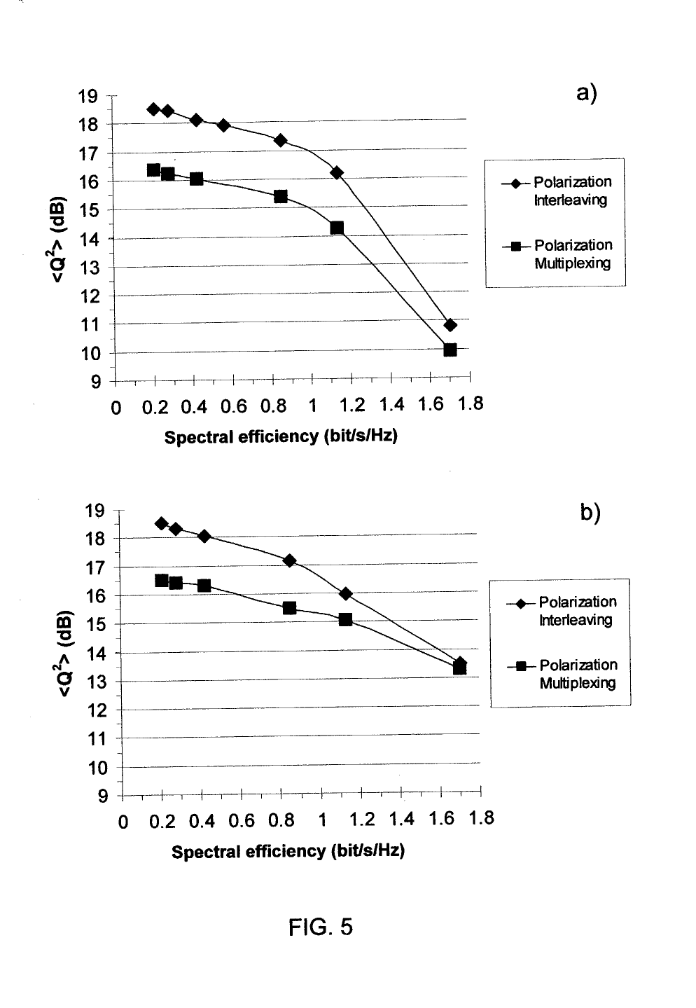

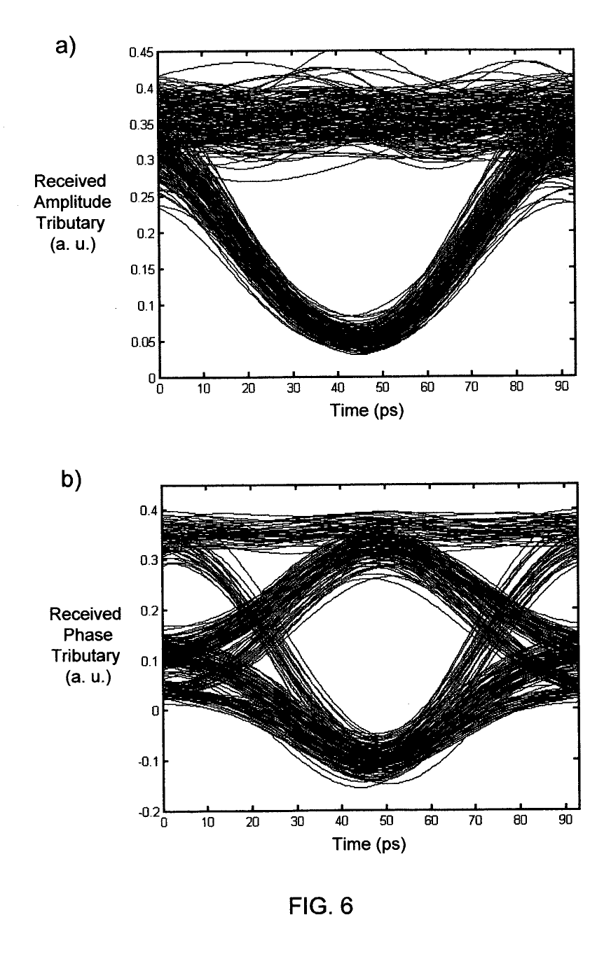

FIG. 5 shows some performance diagrams numerically evaluated for systems of the type of FIG. 1a and FIG. 2;

FIG. 6 shows some eye diagrams numerically calculated for the amplitude and phase tributaries received in systems of the type of FIG. 1a and FIG. 2.

### DETAILED DESCRIPTION OF THE INVENTION

The scheme of FIG. 1a describes an optical communication system 100 according to a first aspect of the present invention, the said optical communication system 100 comprising: a first apparatus 110 to transmit at least a digital optical signal 120, an optical transmission line 114, optically connected to the said first apparatus 110, for the propagation of the said optical signal 120 and a second apparatus 150, optically connected to the said optical transmission line 114, to receive the said optical signal 120.

The said first apparatus 110 to transmit an optical signal 120 includes:

a) a laser light source 102, that furnishes a substantially continuous flow of optical radiation to the wavelengths typical of the optical communications, and preferably in the optical fiber third transmission window, in the region of 1500-1600 nm;

b) an optical intensity modulator 104, having at input a substantially continuous flow of optical radiation with linear polarization, to produce an encoded sequence of dark pulses 410 in the said optical signal 120, the said encoded sequence of dark pulses 410 being representative of a first data sequence 131 and having bit rate R and bit period T_{B}=1/R (Amplitude Tributary). The said optical intensity modulator 104 is for example of the conventional Mach Zehnder interferometric type, preferably not producing any significant phase chirp in the said optical signal 120;

c) an electrical driving circuit 130 for the said optical intensity modulator 104, having at input a first electrical data signal 131 of type Non Return Zero (NRZ) at bit rate R, and a clock signal 132 at the same bit rate R having a delay Δt_{Aclock} respect the said first electrical data signal 131;

d) an electrical bias potential difference V_{A bias} 106 applied to the said optical intensity modulator 104. Typically, the electrical potential V_{A bias} 106 and the voltage V_{A drive} applied by the said electrical driving circuit 130 are such to obtain the maximum of transmission in the said modulator 104 in correspondence of a space bit (logical zero) in the said first data sequence 131, and the minimum of transmission in correspondence of a mark bit (logical one); if the said modulator 104 is of Mach Zehnder type, the electrical potential V_{A bias} 106 can be for instance equal to around V_{π}/2, where V_{π} is the potential difference to apply to the said modulator 104 to get substantially no transmission, and voltage V_{A drive} applied by the said driving circuit 130 can vary for instance between −V_{π}/2 and V_{π}/2;

e) an optical phase modulator 108 to produce an encoded phase modulation 420 in the said optical signal 120, the said encoded phase modulation 420 (Phase Tributary) being representative of a second data sequence 141 and having bit rate R, amplitude Δφ, bit period T_{B}=1/R and delay τ_{φ}−τ_{A} respect to the said encoded sequence of dark pulses 410. The said optical phase modulator 108 is of the conventional wideband type, with substantially linear response over an electrical bandwidth comparable with that of the said second data sequence 141; it can for instance be realized by an optical waveguide on a LiNbO₃ substrate; the said phase LiNbO₃ modulator is polarization sensitive, but capable to modulate the phase of the said optical signal 120 with linear polarization;

f) an electrical driving circuit 140 for the said optical phase modulator 108, having at input a second electrical data signal 141 of type Non Return Zero (NRZ) at the bit rate R, and a clock signal 142 at the same bit rate R having delay Δt_{φclock} respect to the said second electrical data signal 141. Voltage V_{φ drive} generated by the said electrical driver 140 has amplitude preferably smaller or equal to V_{πφ}, where V_{πφ} is the potential difference to be applied to the said modulator 108 to obtain a phase shift equal to 180°.

The said optical transmission line 114 typically consists of optical fibers resulting monomodal at the transmission wavelength, for example of type NZ-DSF (Non-Zero Dispersion Shifted Fiber) or DS (Dispersion Shifted) or SMF (Standard Monomodal Fiber). The said optical transmission line 114 may also include optical amplifiers, for example of type EDFA (Erbium-Doped Fiber Amplifier) or Raman or of the semiconductor type, inserted in cascade every, for example, 80 km of optical fiber. The said optical transmission line 114 may also include other optical devices like, among the others, multiplexers and de-multiplexers for WDM signals, ADMs (Add-Drop Multiplexers), OXCs (Optical Cross Connects), optical and opto-electronic regenerators.

The said second apparatus 150 to receive the said optical signal 120 includes:

h) an optical filter 116 to select in frequency the said optical signal 120. The said optical filter 116 can be realized, for instance, through a WDM de-multiplexer of type AWG (Arrayed Waveguide Grating), a BG filter (Bragg Grating), and a Fabry Perot or Mach Zehnder interferometric filter;

i) a polarization controller 118 capable to substantially recover the initial power distribution between the two linear polarization components of the said optical signal 120. Typically, the said polarization controller 118 is conventionally able to correct a state of polarization (SOP) arbitrarily varying in time; preferably it is able to substantially recover the initial state of polarization of the said optical signal 120. The said polarization controller 118 can be, for instance, of the Heismann type. Eventually, the use of the said polarization controller 118 may be omitted for widely spaced WDM channels.

l) a linear analyzer 122 to select the linear polarization component of the said optical signal 120 where most of the optical power is distributed. The said linear analyzer 122 can be realized, for example, through a conventional fiber or waveguide Polarizing Beam Splitter (PBS);

m) a non-polarizing beam splitter 124 to split the said optical signal 120 and apply the two portions to respectively an optical intensity receiver 126 and an optical phase receiver 128. The said non-polarizing beam splitter 124, can be for example a 1×2 coupler in fused fiber or in waveguide;

n) an optical intensity receiver 126 of type for intensity modulation with direct detection (IM-DD), including an electrical circuit to reverse the polarity of the received electrical signal. A scheme example of the said intensity receiver 126 is shown in FIG. 3d;

o) an optical phase receiver 128, for the phase detection of the said optical signal 120, including an electrical circuit to reverse the polarity of the received electrical signal. A scheme example for the said optical phase receiver 128 is shown in FIG. 3e, for the case of Differential Phase Shift Keying (DPSK), and will be described in detail in the following.

The optical communication system according to the first aspect of the invention has the advantage to double the transport capacity in comparison to a traditional IM-DD system, without necessarily broadening the said optical signal bandwidth, thus increasing the system spectral efficiency [bit/s/Hz]; the said communication system is capable to optically multiplex and de-multiplex an Amplitude Tributary and a Phase Tributary on a same WDM channel.

In this description, a “dark pulse” is a temporal region of reduced optical power produced on a substantially continuous flow of optical radiation, over a certain portion Δt₁ (412) of the bit period T_{B}. The said encoded sequence of dark pulses 410 is characterized by having nearly unperturbed intensity on a portion T_{B}−Δt₁ (414) of the bit period T_{B}, independently on the transmitted bit; the said encoded phase modulation 420 advantageously uses the said portion T_{B}−Δt₁ of the bit period T_{B} to add a phase code representative of a second tributary.

Preferably, the said encoded phase modulation 420 in the said optical signal 120 is of Non Return Zero (NRZ) type.

More preferably, the said encoded phase modulation 420 in the said optical signal 120 is of the type shown in FIG. 4e, with positive and negative pulses respect to an average value.

Typically, the said encoded phase modulation 420 in the said optical signal 120 is of Differential Phase Shift Keying (DPSK) type, and the said second electrical data signal 141 for the said optical phase modulator 108 has differential encoding. In the conventional differential encoding, one of the two binary symbols (for instance the logical one) is represented by a transition between the two logical levels of the said second electrical data signal 141, while the other binary symbol (for instance the logical zero) is represented by the absence of transition. In the conventional DPSK detection technique, a received optical signal is split in two portions; one is delayed of a bit period T_{B}, the other is directly recombined with the first delayed.

Typically, the said optical phase receiver is of DPSK type.

Preferably, the amplitude Δφ of the said encoded phase modulation 420 is smaller or equal to 180°, and the delay τ_{φ}−τ_{A} respect to the said encoded sequence of dark pulses 410 is approximately equal to (h+1/2)T_{B}, with h an integer number.

Typically, the said polarization controller 118 is able to correct a state of polarization (SOP) varying in time in arbitrary way.

Preferably, the said polarization controller 118 is able to substantially recover the initial state of polarization of the said optical signal 120.

Typically, the electrical signals at the output of the intensity and phase (DPSK) receivers are of the illustrated type in FIG. 6a and 6b, and once inverted of polarities show characteristics similar to the Return Zero (RZ) modulation format. This feature may help using standard RZ electronics on the receivers of the said communication system.

In an alternative embodiment (not shown) of the said optical communication system 100, the said polarization controller 118 and linear analyzer 122 may be omitted; indeed, in the case of WDM channels with non-overlapping spectra, some of the optical intensity receivers 126 and optical phase receivers 128 known in the literature may work properly with an arbitrary received state of polarization.

The modulation format described by the first aspect of the present invention is referred here as Phase and Intensity Modulation (PhIM), since based substantially on the modulation of an Amplitude Tributary, or intensity, and a Phase Tributary.

In a second aspect, the present invention relates to a device 105 for modulating a digital optical signal 120, the said device 105 comprising:

a) an optical intensity modulator 104, having at input a substantially continuous flow of optical radiation with linear polarization, to produce an encoded sequence of dark pulses 410 in the said optical signal 120, the said encoded sequence of dark pulses 410 being representative of a first data sequence 131 and having bit rate R and bit period T_{B}=1/R;

b) an electrical driving circuit 130 for the said optical intensity modulator 104, having at input a first electrical data signal 131 of type Non Return Zero (NRZ) at bit rate R, and a clock signal 132 at the same bit rate R having a delay Δt_{Aclock} respect the said first electrical data signal 131;

c) an electrical bias potential difference V_{A bias} 106 applied to the said optical intensity modulator 104;

d) an optical phase modulator 108 to produce an encoded phase modulation 420 in the said optical signal 120, the said encoded phase modulation 420 being representative of a second data sequence 141 and having bit rate R, amplitude Δφ, bit period T_{B}=1/R and delay τ_{φ}−τ_{A} respect to the said encoded sequence of dark pulses 410;

e) an electrical driving circuit 140 for the said optical phase modulator 108, having at input a second electrical data signal 141 of type Non Return Zero (NRZ) at the bit rate R, and a clock signal 142 at the same bit rate R having delay Δt_{φclock} respect to the said second electrical data signal 141.

The characteristics of the said device 105 for modulating a digital optical signal 120 have been described in relation to the first aspect of the present invention.

The scheme of FIG. 2 describes a communication system 200 according to a third aspect of the present invention, the said optical communication system 200 comprising a first apparatus 210 to transmit at least one digital optical signal 225, an optical transmission line 114, optically connected to the said first apparatus 210, for the propagation of the said optical signal 225 and a second apparatus 250, optically connected to the said optical transmission line 114, to receive the said optical signal 225.

The said first apparatus 210 to transmit a digital optical signal 225 includes:

a) a laser light source 102 that furnishes a substantially continuous flow of optical radiation;

b) a beam splitter 203 to divide the said continuous flow of optical radiation in two components of linear polarization;

c) a device 205 for modulating a digital optical signal 220 according to the said second aspect of the present invention, having at input a substantially continuous flow of optical radiation with linear polarization;

d) a second device 206 for modulating a digital optical signal 221 according to the said second aspect of the present invention, having at input a substantially continuous flow of optical radiation with linear polarization;

e) a polarizing coupler 212 to recombine the said digital optical signals 220, 221 with orthogonal polarizations between them; the said coupler 212 having at output the said digital optical signal 225.

The said optical transmission line 114 characteristics have already been described in relation to the first aspect of the present invention, FIG. 1a.

The said second apparatus 250 to receive the said optical signal 225 includes:

f) an optical filter 116 to select in frequency the said optical signal 225;

g) a non polarizing beam splitter 217 to divide the said optical signal 225 and apply the two portions to one or more polarization controllers 118;

h) one or more polarization controllers 118 capable to substantially recover the initial power distribution between the two linear polarization components of the said optical signal 225. Typically, the said polarization controllers 118 are conventionally able to correct a state of polarization varying in time in arbitrary way; preferably they are able to substantially recover the initial state of polarization of the said optical signal 225;

i) a first linear analyzer 122 to select a first of the two linear polarization components on which the said optical signal 225 power is distributed;

l) a second linear analyzer 222 to select the second of the two linear polarization components on which the optical power of the said optical signal 225 is distributed;

m) two non-polarizing beam splitters 124 to split the optical power of the said linear polarization components and to apply the two portions respectively to two optical intensity receivers 126 and two optical phase receivers 128;

n) two optical intensity receivers 126 of the IM-DD type, for the detection of the optical intensity of the two linear polarization components of the said optical signal 225, comprehensive of electrical circuits for reversing the polarity of the received electrical signals;

o) two optical phase receivers 128, for the detection of the optical phase of the two linear polarization components of the said optical signal 225, comprehensive of electrical circuits for the polarity inversion of the received electrical signals. Preferably, the said optical phase 128 receivers are of DPSK type.

The said digital optical signal 220 has amplitude and phase tributaries at bit rate R₁, the said digital optical signal 221 has amplitude and phase tributaries at bit rate R₂. Preferably but not necessarily, bit rate R₁ equals R₂, and the two amplitude tributaries are synchronized between them, as well as the two phase tributaries.

Further characteristics of system in FIG. 2, and of the used electrical and optical signals, have been described in relation to the first and the second aspect of the present invention; for the details, reference should be made to the preceding text.

The optical communication system according to the third aspect of the invention has the advantage to quadruple the transport capacity respect to a traditional IM-DD system, without necessarily broadening the said optical signal bandwidth, therefore increasing the spectral efficiency of the system; the said communication system is able to optically multiplex and de-multiplex two Amplitude Tributaries and two Phase Tributaries on a same WDM channel.

The modulation format described by the third aspect of the present invention is referred to as Phase and Intensity Modulation with Polarization Domain Multiplexing (PhIM-PDM), since it is based on the polarization multiplexing of two PhIM signals.

FIG. 1b illustrates a scheme of the said electrical driving circuit 130 for the said optical intensity modulator 104, according to a first embodiment of the said device 105 for modulating a digital optical signal 120, to be used in the systems and modulators according to the first, second and third aspect of the present invention. The said electrical driving circuit 130 includes, among the other things:

c1) a high speed logical AND gate 134 having at input the said first electrical data signal 131 and the clock 132. The said logical AND gate 134 can be realized, for instance, through an integrated GaAs module,

c2) an electrical amplifier 136 to amplify the electrical signal obtained by the logical AND operation of the said first electrical data signal 131 and clock 132,

c3) an electrical delay line 138 to delay by a time τ_{A} the electrical signal obtained by the logical AND operation of the said first electrical data signal 131 and clock 132.

FIG. 3a illustrates a scheme of the said electrical driving circuit 130 for the said optical intensity modulator 104, according to a second embodiment of the said device 105 for modulating a digital optical signal 120, to be used in the systems and modulators according to the first, second and third aspect of the present invention. The said electrical driving circuit 130 includes, among the others:

c1) a multiplier circuit 334 to multiply the said first electrical data signal 131 and the clock 132,

c2) an electrical amplifier 136 to amplify the electrical signal obtained by the multiplication of the said first electrical data signal 131 and clock 132,

c3) an electrical delay line 138 to delay by a time τ_{A} the electrical signal obtained by the multiplication of the said first electrical data signal 131 and clock 132.

Preferably, the electrical devices described in points c1), c2) and c3) for the FIGS. 1b and 3a have comparable or greater electrical bandwidth to that of the said electrical data signal 131 and clock 132.

Typically, the electrical signal V_{A drive} at the output of the said electrical driving circuit 130 is of the type shown in FIG. 4b, with RZ format or its complementary.

FIG. 1c illustrates a scheme of the said electrical driving circuit 140 for the said optical phase modulator 108, according to a third embodiment of the said device 105 for modulating a digital optical signal 120, to be used in the systems and modulators according to the first, second and third aspect of the present invention. The said electrical driving circuit 140 includes, among the other things:

f1) a first high speed AND logical gate 144 having at input the said second electrical data signal 141 and clock 142,

f2) a second high speed AND logical gate 145 having at input the logical NOT of the said second electrical data signal 141 and the said clock 142,

f3) a subtractor circuit 146 having at input the outputs of the said first and second AND gates 144÷145,

f4) an electrical amplifier 147 to amplify the electrical signal obtained by the subtraction of the outputs of the said first and second AND gates 144÷145,

f5) an electrical delay line 148 to delay by a time τ_{φ} the electrical signal obtained by the subtraction of the outputs of the said first and second AND gates 144÷145.

FIG. 3b illustrates a scheme of the said electrical driving circuit 140 for the said optical phase modulator 108, according to a fourth embodiment of the said device 105 for modulating a digital optical signal 120, to be used in the systems and modulators according to the first, second and third aspect of the present invention. The said electrical driving circuit 140 includes, among the other things:

f1) a subtractor circuit 342, to subtract to the said second electrical data signal 141 a substantially constant electrical signal V_{φ depth} 344, having at output a difference electrical signal V_{sub} 346,

f2) a multiplier circuit 348 to multiply the said difference electrical signal 346 and clock 142,

f3) an electrical amplifier 147 to amplify the electrical signal obtained by the multiplication of the said difference electrical signal 346 and the clock 142,

f4) an electrical delay line 148 to delay by a time τ_{φ} the electrical signal obtained by the multiplication of the said difference electrical signal 346 and the clock 142.

FIG. 3c illustrates a scheme of the said electrical driving circuit 140 for the said optical phase modulator 108, according to a fifth embodiment of the said device 105 for modulating a digital optical signal 120, to be used in the systems and modulators according to the first, second and third aspect of the present invention. The said electrical driving circuit 140 includes, among the others:

f1) an electrical amplifier 147 to amplify the said second electrical data signal 141,

f2) an electrical delay line 148 to delay by a time τ_{φ} the said second electrical data signal 141.

Preferably, the electrical devices described in points from f1) to f5) for FIGS. 1c, 3b and 3c have comparable or greater electrical bandwidth to that of the said electrical data signal 141 and clock 142.

Typically, the electrical signal V_{φ drive} at the output of the said electrical driving circuit 140 is of the type shown in FIG. 4e, or of NRZ type for the circuit in FIG. 3c.

Preferably, the said second electrical data signal 141 for the said optical phase modulator 108 is differentially encoded, suitable for a DPSK optical phase modulation.

FIG. 3d shows a possible simplified scheme of the said optical intensity receiver 126, of the type for IM-DD signals, to be used in the systems according to the first and third aspect of the present invention. The said optical intensity receiver 126 includes, among the other things:

n1) a high speed photodiode, for instance of PIN type, to convert the optical signal 350, arriving from the non-polarizing beam splitter 124, into a proportional electrical signal,

n2) an electrical front-end 352 comprising, among the others, an electrical amplifier and a low-pass electrical filter. The said electrical filter can be, for example, a fourth order Bessel Thompson with bandwidth comparable with the modulation band,

n3) an electrical circuit 354 for the polarity inversion of the received electrical signal, to produce an output electrical signal 360 similar to the Return Zero (RZ) format, as that shown in FIG. 6a (before the polarity inversion).

FIG. 3e illustrates a possible simplified scheme of the said optical phase receiver 128, for the differential phase case (DPSK), to be used in the systems according to the first and third aspect of the present invention. The said receiver of optical phase 128 includes, among the other things:

o1) a beam splitter 372 to divide the optical signal 370, coming from the said non-polarizing beam splitter 124, in two linear polarization components,

o2) an optical delay line 374, to delay by a time around T_{B} one of the two components,

o3) a coupler 373, opportunely rotated respect to the two components, having at output two optical signals respectively equal to the sum and the difference of the two polarization components,

o4) two high speed photodiodes 375, for instance of type PIN, to convert the two optical signals, coming from the said coupler 373, in two proportional electrical signals,

o5) a subtractor circuit 376, to subtract the two said electrical signals. If Aₓ(t) is the complex amplitude of the optical field 370, at the said subtractor 376 output an electrical signal is given, proportional to Re[Aₓ(t) Aₓ*(t−T_{B})],

o6) an electrical front-end 377 comprising, among the others, an electrical amplifier and a low-pass electrical filter. The said electrical filter can be, for instance, a fourth order Bessel Thompson with bandwidth comparable with the modulation one,

o7) an electrical circuit 378 for the polarity inversion of the received electrical signal, to produce an output electrical signal 380 similar to the Return Zero (RZ) format, as that shown in FIG. 6b (before the polarity inversion).

The receiver schemes shown in FIGS. 3d and 3e, excluded the circuits for the polarity inversion 354 and 378, are well known in literature and are not object of the present invention. Further phase receiver schemes of DPSK type are described by patents U.S. Pat No. 5,181,136 and U.S. Pat. No. 5,355,243.

FIG. 4 illustrates some temporal diagrams of the electrical and optical signals used by systems and modulators according to the present invention. In FIG. 4c it is shown a typical diagram in the time domain of the said encoded sequence of dark pulses 410 in the said optical signal 120. FIGS. 4d and 4e show some typical temporal diagrams of the said encoded phase modulation 420 in the said optical signal, respectively for phase with Non Return Zero (NRZ) format and with positive and negative pulses respect to an average value.

Comparing FIGS. 4c, 4d and 4e, to the person with skill in the art will be clear that the said optical signal 120 generally don't have a dark soliton modulation format.

The optical communication systems according to the first and third aspect of the present invention are typically used for the wavelength division multiplexing (WDM) transmission with high spectral efficiency. In a further embodiment (not shown), the said systems may include more apparatuses to transmit a plurality of optical signals 120 or 225 at different wavelengths, more apparatuses to receive the amplitude and phase tributaries of the said optical signals, and conventional wavelength multiplexers and de-multiplexers to simultaneously transmit the said optical signals in the said transmission line 114.

In a fourth aspect, the present invention relates to a method for transmitting a digital optical signal 120 comprising the steps of:

a) modulating the intensity of a substantially continuous flow of optical radiation with linear polarization, to produce an encoded sequence of dark pulses 410 in the said optical signal 120, the said encoded sequence of dark pulses (Amplitude Tributary) being representative of a first data sequence 131 and having:

a1) bit rate R and bit period T_{B}=1/R,

a2) reduced or zero optical intensity over a certain portion Δt₁ (412) of the bit period T_{B}, in correspondence of the bits of the said first data sequence 131 which are related to the said dark pulses (for instance, the marks),

a3) nearly unperturbed intensity, in correspondence of the bits of the said first data sequence 131 which are not related to the said dark pulses (for instance, the spaces),

a4) in every case, nearly unperturbed intensity on a portion T_{B}−Δt₁ (414) of the bit period T_{B};

b) modulating the optical phase in the said optical signal 120, to produce an encoded phase modulation 420, the said encoded phase modulation (Phase Tributary) being representative of a second data sequence 141 and characterized by:

b1) having bit rate R, amplitude Δφ, bit period T_{B}=1/R and delay τ_{φ}−τ_{A} respect to the said encoded sequence of dark pulses 410;

b2) using the said portion T_{B}−Δt₁ of the bit period T_{B} to add a phase code representative of the said second data sequence 141.

Preferably, the said encoded phase modulation 420 in the said optical signal 120 is of Non Return Zero (NRZ) type.

More preferably, the said encoded phase modulation 420 in the said optical signal 120 is of the type shown in FIG. 4e, with positive and negative pulses respect to an average value.

Typically, the said encoded phase modulation 420 in the said optical signal 120 is of differential (DPSK) type.

Preferably, the amplitude Δφ of the said encoded phase modulation 420 is less than or equal to 180°, and delay τ_{φ}−τ_{A} respect to the said encoded sequence of dark pulses 410 is approximately equal to (h+1/2)T_{B}, with h an integer number.

In all the aspects of the present invention, the optical connections among the said laser source, optical intensity modulator and optical phase modulator is for instance implemented through the use of polarization maintaining optical fibers, or by fiber polarization controllers, to maintain the necessary linear polarization at the modulator inputs.

Detailed description of FIGS. 5 and 6 are postponed to the text below.

### Numerical Results

In order to evaluate the performances of systems according to the first and third aspect of the present invention, the inventor has performed a series of accurate numerical simulations in the case of WDM transmission. The used model for the transmission line 114 is the nonlinear Schrödinger equation in its most general vectorial form, numerically integrated through the well-known Fourier beam propagation method (BPM). Several physical effects have been modeled in exact way, like: group velocity dispersion (GVD) of second and third order, optical Kerr nonlinearity, polarization mode dispersion (PMD), linear attenuation, amplified spontaneous emission (ASE) noise in the optical amplifiers, modeling of the optical and opto-electronic components with their finite bandwidths.

In a first case, each WDM channel is generated by a transmitter with the scheme 210 in FIG. 2 (PhIM-PDM transmission, or Polarization Multiplexing). Channels at different wavelength are multiplexed by a non polarization maintaining arrayed waveguide grating (AWG); the state of polarization of each channel at the AWG output is therefore rigidly rotated on the Poincaré sphere in a random way.

The four NRZ electrical data signals, multiplexed in a WDM channel, have bit rate R=10.66 Gbit/s each, thus including a forward error correction (FEC) overhead, in order to increase the system performance margins. The capacity of each WDM channel is therefore 40 Gbit/s after the FEC decoding.

Driving circuits 130 produce signals V_{A1 drive} and V_{A2 drive} of the type shown in FIG. 4b. The intensity modulators 104 are of Mach Zehnder type, with 15 dB extinction ratio and 20 ps rise time for the optical signal; they generate two encoded sequences of dark pulses 410.

Driving circuits 140 generate signals V_{φ1 drive} e V_{φ2 drive} of the type shown in FIG. 4e; the phase modulators produce a proportional optical phase 420, with delay τ_{φ}−τ_{A}=T_{B}/2=46.5 ps respect to the said encoded sequence of dark pulses 410; rise time for the optical phase is 20 ps.

Phase modulation is of differential (DPSK) type; in the ideal case, an amplitude Δφ=180° permits to receive the phase tributary with the highest performance; since phase tributary generally shows better performances respect to the amplitude tributary, an amplitude Δφ smaller than 180° could be fixed to equalize the two tributaries received performances. In the considered example, an optimal phase in that sense is approximately 130°.

In WDM signal, central channel is at 1550 nm wavelength; signal is transmitted over a typical long-haul terrestrial transmission line 114, with 500 km length, constituted by six 80 km spans of NZ-DSF fiber with the following parameters: dispersion D=4.2 ps/nm/km at 1550 nm, dispersion slope S=0.082 ps/nm²/km, effective area A_{eff}=72 μm², attenuation α=0.2 dB/km, nonlinear coefficient n₂=2.6×10⁻²⁰ m²/W, polarization mode dispersion PMD=0.1 ps/√km, correlation length L_{c}=100 m.

After each span an EDFA optical amplifier is inserted, with 16 dB gain, 5 dB noise figure and flat gain spectrum over the WDM bandwidth.

At the end of the line 114 it is inserted a 15 km span of dispersion compensating fiber (DCF), with the following parameters: dispersion D=−134.4 ps/nm/km at 1550 nm, dispersion slope S=−1.44 ps/nm²/km, effective area A_{eff}=20 μm², attenuation α=0.5 dB/km, nonlinear coefficient n₂=2.6×10⁻²⁰ m²/W, polarization mode dispersion PMD=0.1 ps/√km, correlation length L_{c}=100 m.

Receiver has the scheme 250, inclusive of an optical pre-amplifier. Two types of optical filter 116 have been considered: a) a first order Gaussian filter with bandwidth equal to half the WDM channels frequency spacing, that models the behavior of an AWG de-multiplexer; b) a fifth order Gaussian filter with bandwidth approximately equal to the channels spacing, modeling for instance a Bragg filter for each WDM channel.

Immediately after the optical filter 116, a further dispersion compensator has been inserted for better compensating the cumulated GVD along the line 114, with dispersion ranging between −200 and +200 ps/nm and optimized for each filtered channel.

Polarization controllers 118 have been modeled multiplying the filtered optical field with the inverse of the Jones matrix, cumulated over the line 114 and calculated at the central wavelength of the filtered WDM channel; therefore, cumulated PMD is ideally recovered only at the channel central frequency.

The intensity receivers 126 have the scheme in FIG. 3d; the electrical filter is a fourth order Bessel Thompson; the receiver cut-off frequency is 12 GHz. Phase receivers 128 have the DPSK scheme in FIG. 3e, with electrical front-end equal to that for the intensity receivers.

In a second case, the WDM channels are generated by transmitters with the scheme 110 in FIG. 1a, and they all have linear polarization. Multiplexing in this case sets adjacent channels with orthogonal polarizations between them; this is typically obtained through the use of two polarization-maintaining AWG, interleaved by a polarizing beam coupler.

The technique used here is referred to as PhIM-PI (PhIM with Polarization Interleaving).

To every WDM channel now correspond two NRZ electrical data signals, with bit rate R=10.66 Gbit/s each; the capacity of every WDM channel is therefore 20 Gbit/s after FEC decoding.

The characteristics of the components for the transmitters 110, transmission line 114 and receiver 150 are the same as the first case described above, with the exception of the optical filter bandwidth 116, which it is now equal to the channel spacing in the case of first order Gaussian filter, and equal to the double of the channel spacing in the case of fifth order Gaussian filter.

Optical filter 116 is generally not able to ideally select the filtered channel; the residual optical power of the side channels is now eliminated by the polarization controller 118 and the linear analyzer 122, because the two adjacent channels have orthogonal polarization respect to the selected one.

Performances are evaluated in terms of Q² factor on the received electrical eye diagrams, for the amplitude and phase tributaries. Q factor is conventionally defined by the expression Q=|m₁−m₀|/(σ₁+σ₀), where m₁, m₀, σ₁, σ₀ are respectively the average and standard deviation for the high and low levels of the received electrical eyes.

Assuming a decision threshold with Gaussian distribution, an error-free transmission, that is with bit error rate (BER) conventionally less than 10⁻⁹, corresponds to a Q² greater than 15.6 dB. The considered FEC encoding allows to gain around 6 dB on the received performances; this means that acceptable system performances are obtained when the Q², evaluated immediately after the electrical polarity inversion and before the FEC decoding, is greater than 9.5 dB.

In PhIM-PDM case, the numerical simulations refer to the transmission of 20 WDM channels with optical frequency spacing variable between 25 and 200 GHz; in the PhIM-PI case 40 channels are considered with spacing between 12.5 and 100 GHz. In both cases, an overall capacity of 800 Gbit/s, after FEC decoding, is transmitted on a typical 500 km terrestrial link. System spectral efficiency, before FEC decoding, varies correspondingly between 1.71 and 0.21 bit/s/Hz.

The optimal optical power at every NZ-DSF fiber input, with nonlinear optical effects yet not considerable, is −4 dBm per channel in the PhIM-PDM case (−7 dBm for each polarization component) and −7 dBm in the PhIM-PI case; power at the DCF input is 8 dB lower.

FIG. 5 illustrates the system average performances at different spectral efficiencies, evaluated at optimal power. It is given the Q² factor averaged among the WDM channels and among the amplitude and phase tributaries; averaging is justified by the fact that amplitude and phase tributaries have equalized performances, and WDM channels have performances that do not differ by more than 1 dB.

FIG. 5a refers to the case of a first order Gaussian optical filter 116. In general, performances are higher by about 2 dB in the PhIM-PI case; this is due to reduced nonlinear effects since the optimal channel power is smaller in comparison to PhIM-PDM. Performances for spectral efficiencies up to 0.8 bit/s/Hz are acceptable even in absence of FEC coding; nevertheless in the case of 1.71 bit/s/Hz efficiency (corresponding to a 12.5 GHz spacing in PhIM-PI and to 25 GHz in PhIM-PDM), performances are acceptable with no considerable system margin.

FIG. 5b refers to the case of a fifth order Gaussian optical filter 116. For efficiencies up to 0.8 bit/s/Hz, differences are not observed in comparison to the case of FIG. 5a; nevertheless, for higher efficiencies the better filter selectivity allows to partially eliminate the penalties due to the interchannel linear cross-talk. In correspondence of a spectral efficiency of 1.71 bit/s/Hz (1.6 after FEC decoding) an acceptable transmission with 4 dB margins at system beginning-of-life is obtained, both in the PhIM-PI and in the PhIM-PDM cases.

Finally, FIGS. 6a and 6b show the received electrical eye diagrams, before the electrical polarity inversion, respectively for the amplitude tributary and the phase tributary, for one of the transmitted channels (channel 24) in the case of PhIM-PI transmission with 25 GHz spacing (0.8 bit/s/Hz efficiency), and with first order optical filter.

Several changes and adaptations may be made to the present invention by persons with skill in the art. Therefore, the scope of the invention is defined by the appended claims and all changes and modifications falling within the equivalence of the scope of the claims are to be embraced by the invention.

I claim:

1. An optical communication system (100) comprising:
a first apparatus (110) to transmit at least a digital optical signal (120), the said first apparatus (110) comprising:
a) a laser light source (102), that furnishes a substantially continuous flow of optical radiation,
b) an optical intensity modulator (104), having at input a substantially continuous flow of optical radiation with linear polarization, to produce an encoded sequence of dark pulses (410) in the said optical signal (120), the said encoded sequence of dark pulses (410) being representative of a first data sequence (131) and having bit rate R and bit period T_{B}=1/R (Amplitude Tributary),
c) an electrical driving circuit (130) for the said optical intensity modulator (104), having at input a first electrical data signal (131) of type Non Return Zero (NRZ) at bit rate R, and a clock signal (132) at the same bit rate R having a delay Δt_{Aclock} respect the said first electrical data signal (131),
d) an electrical bias potential difference V_{A bias} (106) applied to the said optical intensity modulator (104),
e) an optical phase modulator (108) to produce an encoded phase modulation (420) in the said optical signal (120), the said encoded phase modulation (420, Phase Tributary) being representative of a second data sequence (141) and having bit rate R, amplitude Δφ, bit period T_{B}=1/R and delay τ_{φ}−τ_{A} respect to the said encoded sequence of dark pulses (410),
f) an electrical driving circuit (140) for the said optical phase modulator (108), having at input a second electrical data signal (141) of type Non Return Zero (NRZ) at the bit rate R, and a clock signal (142) at the same bit rate R having delay Δt_{φclock} respect to the said second electrical data signal (141);
an optical transmission line (114), optically connected to the said first apparatus (110), for the propagation of the said optical signal (120);
a second apparatus (150), optically connected to the said optical transmission line (114), to receive the said optical signal (120), the said second apparatus (150) comprising:
h) an optical filter (116) to select in frequency the said optical signal (120),
m) a non-polarizing beam splitter (124) to split the said optical signal (120) and apply the two portions to respectively an optical intensity receiver (126) and an optical phase receiver (128),
n) an optical intensity receiver (126) of type for intensity modulation with direct detection (IM-DD), including an electrical circuit to reverse the polarity of the received electrical signal,
o) an optical phase receiver (128), for the phase detection of the said optical signal (120), including an electrical circuit to reverse the polarity of the received electrical signal.

2. An optical communication system (100) according to claim 1 wherein the said second apparatus (150), to receive the said optical signal (120), further comprises:
i) a polarization controller (118) capable to substantially recover the initial power distribution between the two linear polarization components of the said optical signal (120),
l) a linear analyzer (122) to select the linear polarization component of the said optical signal (120) where most of the optical power is distributed.

3. An optical communication system (100) according to claim 2, characterized in that the said electrical driving circuit (130) for the said optical intensity modulator (104) comprises:
c1) a high speed logical AND gate (134) having at input the said first electrical data signal (131) and the clock (132),
c2) electrical devices to amplify (136) and delay by a time τ_{A} (138) the electrical signal obtained by the logical AND operation of the said first electrical data signal (131) and clock (132).

4. An optical communication system (100) according to claim 2, characterized in that the said electrical driving circuit (130) for the said optical intensity modulator (104) comprises:
c1) a multiplier circuit (334) to multiply the said first electrical data signal (131) and the clock (132),
c2) electrical devices to amplify (136) and delay by a time τ_{A} (138) the electrical signal obtained by the multiplication of the said first electrical data signal (131) and clock (132).

5. An optical communication system (100) according to claim 2, characterized in that the said electrical driving circuit (140) for the said optical phase modulator (108) comprises:
f1) a first high speed AND logical gate (144) having at input the said second electrical data signal (141) and clock (142),
f2) a second high speed AND logical gate (145) having at input the logical NOT of the said second electrical data signal (141) and the said clock (142),
f3) a subtractor circuit (146) to subtract the outputs signals of the said first and second AND gates (144,145),
f4) electrical devices to amplify (147) and delay by a time τ_{φ} (148) the electrical signal obtained by the subtraction of the outputs of the said first and second AND gates (144,145).

6. An optical communication system (100) according to claim 2, characterized in that the said electrical driving circuit (140) for the said optical phase modulator (108) comprises:
f1) a subtractor circuit (342), to subtract to the said second electrical data signal (141) a substantially constant electrical signal V_{φ depth} (344), having at output a difference electrical signal V_{sub} (346),
f2) a multiplier circuit (348) to multiply the said difference electrical signal (346) and clock (142),
f3) electrical devices to amplify (147) and delay by a time τ_{φ} (148) the electrical signal obtained by the multiplication of the said difference electrical signal (346) and the clock (142).

7. An optical communication system (100) according to claim 2, characterized in that the said electrical driving circuit (140) for the said optical phase modulator (108) comprises:
f1) electrical devices to amplify (147) and delay by a time τ_{φ} (148) the said second electrical data signal (141).

8. An optical communication system (100) according to claim 2, characterized in that the said encoded phase modulation (420) in the said optical signal (120) is in Non Return Zero (NRZ) format.

9. An optical communication system (100) according to claim 2, characterized in that the said encoded phase modulation (420) in the said optical signal (120) is of the type shown in FIG. 4e, with positive and negative pulses respect to an average value.

10. An optical communication system (100) according to claim 2, characterized in that the said encoded phase modulation (420) in the said optical signal (120) is of Differential Phase Shift Keying (DPSK) type, and the said second electrical data signal (141) for the said optical phase modulator (108) has differential encoding.

11. An optical communication system (100) according to claim 2, characterized in that the said electrical signal V_{A drive} at the output of the said electrical driving circuit (130) is in RZ format or its complementary.

12. A device (105) for modulating a digital optical signal (120), the said device (105) comprising:
a) an optical intensity modulator (104), having at input a substantially continuous flow of optical radiation with linear polarization, to produce an encoded sequence of dark pulses (410) in the said optical signal (120), the said encoded sequence of dark pulses (410) being representative of a first data sequence (131) and having bit rate R and bit period T_{B}=1/R,
b) an electrical driving circuit (130) for the said optical intensity modulator (104), having at input a first electrical data signal (131) of type Non Return Zero (NRZ) at bit rate R, and a clock signal (132) at the same bit rate R having a delay Δt_{Aclock} respect the said first electrical data signal (131),
c) an electrical bias potential difference V_{A bias} (106) applied to the said optical intensity modulator (104),
d) an optical phase modulator (108) to produce an encoded phase modulation (420) in the said optical signal (120), the said encoded phase modulation (420) being representative of a second data sequence (141) and having bit rate R, amplitude Δφ, bit period T_{B}=1/R and delay τ_{φ}−τ_{A} respect to the said encoded sequence of dark pulses (410),
e) an electrical driving circuit (140) for the said optical phase modulator (108), having at input a second electrical data signal (141) of type Non Return Zero (NRZ) at the bit rate R, and a clock signal (142) at the same bit rate R having delay Δt_{φclock} respect to the said second electrical data signal (141).

13. A device (105) for modulating a digital optical signal (120) according to claim 12, characterized in that the said electrical driving circuit (130) for the said optical intensity modulator (104) comprises:
c1) a high speed logical AND gate (134) having at input the said first electrical data signal (131) and the clock (132),
c2) electrical devices to amplify (136) and delay by a time τ_{A} (138) the electrical signal obtained by the logical AND operation of the said first electrical data signal (131) and clock (132).

14. A device (105) for modulating a digital optical signal (120) according to claim 12, characterized in that the said electrical driving circuit (130) for the said optical intensity modulator (104) comprises:
c1) a multiplier circuit (334) to multiply the said first electrical data signal (131) and the clock (132),
c2) electrical devices to amplify (136) and delay by a time τ_{A} (138) the electrical signal obtained by the multiplication of the said first electrical data signal (131) and clock (132).

15. A device (105) for modulating a digital optical signal (120) according to claim 12, characterized in that the said electrical driving circuit (140) for the said optical phase modulator (108) comprises:
f1) a first high speed AND logical gate (144) having at input the said second electrical data signal (141) and clock (142),
f2) a second high speed AND logical gate (145) having at input the logical NOT of the said second electrical data signal (141) and the said clock (142),
f3) a subtractor circuit (146) to subtract the outputs signals of the said first and second AND gates (144,145),
f4) electrical devices to amplify (147) and delay by a time τ_{φ} (148) the electrical signal obtained by the subtraction of the outputs of the said first and second AND gates (144,145).

16. A device (105) for modulating a digital optical signal (120) according to claim 12, characterized in that the said electrical driving circuit (140) for the said optical phase modulator (108) comprises:
f1) a subtractor circuit (342), to subtract to the said second electrical data signal (141) a substantially constant electrical signal V_{φ depth} (344), having at output a difference electrical signal V_{sub} (346),
f2) a multiplier circuit (348) to multiply the said difference electrical signal (346) and clock (142),
f3) electrical devices to amplify (147) and delay by a time τ_{φ} (148) the electrical signal obtained by the multiplication of the said difference electrical signal (346) and the clock (142).

17. A device (105) for modulating a digital optical signal (120) according to claim 12, characterized in that the said electrical driving circuit (140) for the said optical phase modulator (108) comprises:
f1) electrical devices to amplify (147) and delay by a time τ_{φ} (148) the said second electrical data signal (141).

18. A device (105) for modulating a digital optical signal (120) according to claim 12, characterized in that the said encoded phase modulation (420) in the said optical signal (120) is in Non Return Zero (NRZ) format.

19. A device (105) for modulating a digital optical signal (120) according to claim 12, characterized in that the said encoded phase modulation (420) in the said optical signal (120) is of the type shown in FIG. 4e, with positive and negative pulses respect to an average value.

20. A device (105) for modulating a digital optical signal (120) according to claim 12, characterized in that the said encoded phase modulation (420) in the said optical signal (120) is of Differential Phase Shift Keying (DPSK) type, and the said second electrical data signal (141) for the said optical phase modulator (108) has differential encoding.

21. A device (105) for modulating a digital optical signal (120) according to claim 12, characterized in that the said electrical signal V_{A drive} at the output of the said electrical driving circuit (130) is in RZ format or its complementary.

22. An apparatus (110) to transmit at least a digital optical signal (120), the said apparatus (110) comprising:
a) a laser light source (102), that furnishes a substantially continuous flow of optical radiation,
b) a device (105) for modulating a digital optical signal (120) according to claim 12, having at input a substantially continuous flow of optical radiation with linear polarization.

23. An apparatus to receive (150) a digital optical signal (120), the said apparatus (150) comprising:
m) a non-polarizing beam splitter (124) to split the said optical signal (120) and apply the two portions to respectively an optical intensity receiver (126) and an optical phase receiver (128),
n) an optical intensity receiver (126) of type for intensity modulation with direct detection (IM-DD), including an electrical circuit to reverse the polarity of the received electrical signal,
o) an optical phase receiver (128), for the phase detection of the said optical signal (120), including an electrical circuit to reverse the polarity of the received electrical signal.

24. An apparatus to receive (150) a digital optical signal (120) according to claim 23, further comprising:
h) an optical filter (116) to select in frequency the said optical signal (120),
i) a polarization controller (118) capable to substantially recover the initial power distribution between the two linear polarization components of the said optical signal (120),
l) a linear analyzer (122) to select the linear polarization component of the said optical signal (120) where most of the optical power is distributed.

25. An apparatus (150) to receive a digital optical signal (120) according to claim 24, wherein the said optical phase receiver (128) is of differential phase modulation (DPSK) type.

26. An optical communication system (200) comprising:
a first apparatus (210) to transmit at least a digital optical signal (225), the said first apparatus (210) comprising:
a) a laser light source (102) that furnishes a substantially continuous flow of optical radiation,
b) a beam splitter (203) to divide the said continuous flow of optical radiation in two components of linear polarization,
c) a device (205) for modulating a digital optical signal (220) according to claim 12, having at input a substantially continuous flow of optical radiation with linear polarization,
d) a second device (206) for modulating a digital optical signal (221) according to claim 12, having at input a substantially continuous flow of optical radiation with linear polarization,
e) a polarizing coupler (212) to recombine the said digital optical signals (220,221) with orthogonal polarizations between them; the said coupler (212) having at output the said digital optical signal (225);
an optical transmission line (114), optically connected to the said first apparatus (210) for the propagation of the said optical signal (225);
a second apparatus (250), optically connected to the said optical transmission line (114), to receive the said optical signal (225), the said second apparatus (250) comprising:
f) an optical filter (116) to select in frequency the said optical signal (225),
g) a non polarizing beam splitter (217) to divide the said optical signal (225) and apply the two portions to one or more polarization controllers (118),
h) one or more polarization controllers (118) capable to substantially recover the initial power distribution between the two linear polarization components of the said optical signal (225),
i) a first linear analyzer (122) to select a first of the two linear polarization components on which the said optical signal (225) power is distributed,
l) a second linear analyzer (222) to select the second of the two linear polarization components on which the optical power of the said optical signal (225) is distributed,
m) two non-polarizing beam splitters (124) to split the optical power of the said linear polarization components and to apply the two portions respectively to two optical intensity receivers (126) and two optical phase receivers (128),
n) two optical intensity receivers (126) of the IM-DD type, for the detection of the optical intensity of the two linear polarization components of the said optical signal (225), comprehensive of electrical circuits for reversing the polarity of the received electrical signals,
o) two optical phase receivers (128), for the detection of the optical phase of the two linear polarization components of the said optical signal (225), comprehensive of electrical circuits for the polarity inversion of the received electrical signals.

27. An optical communication system (200) according to claim 26, characterized in that the said optical phase receivers (128) are of differential phase modulation (DPSK) type.

28. An apparatus (210) to transmit at least a digital optical signal (225), the said apparatus (210) comprising:
a) a laser light source (102) that furnishes a substantially continuous flow of optical radiation,
b) a beam splitter (203) to divide the said continuous flow of optical radiation in two components of linear polarization,
c) a device (205) for modulating a digital optical signal (220) according to claim 12, having at input a substantially continuous flow of optical radiation with linear polarization,
d) a second device (206) for modulating a digital optical signal (221) according to claim 12, having at input a substantially continuous flow of optical radiation with linear polarization,
e) a polarizing coupler (212) to recombine the said digital optical signals (220,221) with orthogonal polarizations between them; the said coupler (212) having at output the said digital optical signal (225).

29. An apparatus (250) to receive a digital optical signal (225), the said apparatus (250) comprising:
g) a non polarizing beam splitter (217) to divide the said optical signal (225) and apply the two portions to one or more polarization controllers (118),
h) one or more polarization controllers (118) capable to substantially recover the initial power distribution between the two linear polarization components of the said optical signal (225),
i) a first linear analyzer (122) to select a first of the two linear polarization components on which the said optical signal (225) power is distributed,
l) a second linear analyzer (222) to select the second of the two linear polarization components on which the optical power of the said optical signal (225) is distributed,
m) two non-polarizing beam splitters (124) to split the optical power of the said linear polarization components and to apply the two portions respectively to two optical intensity receivers (126) and two optical phase receivers (128),
n) two optical intensity receivers (126) of the IM-DD type, for the detection of the optical intensity of the two linear polarization components of the said optical signal (225), comprehensive of electrical circuits for reversing the polarity of the received electrical signals,
o) two optical phase receivers (128), for the detection of the optical phase of the two linear polarization components of the said optical signal (225), comprehensive of electrical circuits for the polarity inversion of the received electrical signals.

30. An apparatus (250) to receive a digital optical signal (225) according to claim 29, further comprising an optical filter (116) to select in frequency the said optical signal (225).

31. An apparatus (250) to receive a digital optical signal (225) according to claim 29, characterized in that the said optical phase receivers (128) are of differential phase modulation (DPSK) type.

32. A method for transmitting a digital optical signal (120) comprising the steps of:
a) modulating the intensity of a substantially continuous flow of optical radiation with linear polarization, to produce an encoded sequence of dark pulses (410) in the said optical signal (120), the said encoded sequence of dark pulses (Amplitude Tributary) being representative of a first data sequence (131) and having:
a1) bit rate R and bit period T_{B}=1/R,
a2) reduced or zero optical intensity over a certain portion Δt₁ (412) of the bit period T_{B}, in correspondence of the bits of the said first data sequence (131) which are related to the said dark pulses,
a3) nearly unperturbed intensity, in correspondence of the bits of the said first data sequence (131) which are not related to the said dark pulses,
a4) in every case, nearly unperturbed intensity on a portion T_{B}−Δt₁ (414) of the bit period T_{B};
b) modulating the optical phase in the said optical signal (120), to produce an encoded phase modulation (420), the said encoded phase modulation (Phase Tributary) being representative of a second data sequence (141) and characterized by:
b1) having bit rate R, amplitude Δφ, bit period T_{B}=1/R and delay τ_{φ}−τ_{A} respect to the said encoded sequence of dark pulses (410),
b2) using the said portion T_{B}−Δt₁ (414) of the bit period T_{B} to add a phase code representative of the said second data sequence (141).

32. A method for transmitting a digital optical signal (120) according to claim 31, characterized in that the said encoded phase modulation (420) in the said optical signal (120) is in Non Return Zero (NRZ) format.

33. A method for transmitting a digital optical signal (120) according to claim 31, characterized in that the said encoded phase modulation (420) in the said optical signal (120) is of the type shown in FIG. 4e, with positive and negative pulses respect to an average value.

34. A method for transmitting a digital optical signal (120) according to claim 31, characterized in that the said encoded phase modulation (420) it of differential phase modulation (DPSK) type.

35. A method for transmitting a digital optical signal according to claim 31, characterized in that the said steps of modulating the optical intensity and the optical phase are applied over two substantially continuous flows of optical radiation with linear polarization, and the obtained digital optical signals (220,221) are recombined with orthogonal polarizations between them, thus obtaining at the output the said digital optical signal (225).
